(19) United States
(12) Patent Application Publication
(10) Pub. No.: US 2025/0149787 A1
(43) Pub. Date: May 8, 2025

(54) COMPACT CLOAKED DIPOLES WITH WIDEBAND OPERATION FOR MULTIBAND ANTENNAS

(71) Applicant: ALPHA WIRELESS LIMITED, Portlaoise (IE)

(72) Inventors: Shakil MD Bhuiyan, Mt Druitt (AU); Peter J. Liversidge, Glenbrook (AU); Martin A. Owen, Jamisontown (AU)

(21) Appl. No.: 18/940,653

(22) Filed: Nov. 7, 2024

Related U.S. Application Data
(60) Provisional application No. 63/547,724, filed on Nov. 8, 2023.

(51) Int. Cl. H01Q 5/15; H01Q 9/44; H01Q 19/10

(52) U.S. Cl. CPC H01Q 5/15; H01Q 9/44; H01Q 19/10

(57) ABSTRACT

Methods and apparatus for use as an antenna assembly are disclosed. In one embodiment, the antenna assembly includes a base portion functioning as an interface between the antenna assembly and a reflector; a base portion to radiator feed structure; and a radiator. The radiator includes: a plurality of resonator arms, each of the resonator arms including a plurality of inductive capacitive filters, the plurality of inductive capacitive filters including a straight-line portion and a meandering portion that act as an inductive portion of the inductive capacitive filter. A gap in the meandering portion acts as a capacitive portion of the inductive capacitive filter. Multiband antenna assemblies that utilize the aforementioned antenna assembly as well as methods of their manufacture and use are also disclosed.

### CROSS-REFERENCE TO RELATED APPLICATIONS

This application claims the benefit of priority to U.S. Provisional Pat. App. Ser. No. 63/547,724 filed Nov. 8, 2023, of the same title, the contents of which being incorporated herein by reference in its entirety.

### TECHNOLOGICAL FIELD

The present disclosure relates generally to the utilization of dipole cloaking filters in multiband antennas, and more particularly in one exemplary aspect to mobile wireless network base station antennas that utilize the aforementioned dipole cloaking filters.

### FIELD OF THE DISCLOSURE

Mobile wireless network base station antennas typically are required to operate over a wide range of frequency sub-bands that correspond to the internationally allocated bands used for this communication technology. New frequency sub-bands are continuously being added to keep pace with increasing network traffic demand, so components used in these antennas need to continue developing to widen their bandwidth of operation to accommodate these new frequency sub-bands. Typically, inside a multiband base station antenna there are a multitude of radiating element arrays corresponding to general groupings of commonly used frequency bands. For example, one set of arrays may operate over 698-960 MHz (e.g., the “low band”) and other arrays are normally present that operate over 1695-2690 MHz (e.g., the “high band”). These radiating elements, most often dipoles, must operate within a given band with satisfactory performance in the presence of other radiating elements that operate in other frequency bands. Unfortunately, the dipoles from these differing bands can disrupt each other due to unwanted resonant behavior or simple scattering of each other's radiated signals. A range of techniques have been developed by antenna designers to mitigate these cross-band effects, but this task gets harder as additional frequency bands of operation continue to expand. In recent years, the “high band” referred to above has been expanded to encompass the 1427-1525 MHz band, commonly referred to as the “L-Band”, so techniques developed previously to allow co-existence between low-band arrays and high-band arrays that operated over 1695-2690 MHz no longer work satisfactorily. Accordingly, new wider-band technology needs to be developed so that, for example, L-band signals are not significantly disrupted by the low-band elements, while keeping disruption to the existing 1695-2690 MHz signals to a minimum.

### SUMMARY

The present disclosure satisfies the foregoing needs by providing, inter alia, multiband antennas that include dipole cloaking filters for improving wideband operation.

In one aspect, an antenna assembly is disclosed. In one embodiment, the antenna assembly includes: a base portion functioning as an interface between the antenna assembly and a reflector; a base portion to radiator feed structure; and a radiator. The radiator includes: a plurality of resonator arms, each of the resonator arms including a plurality of inductive capacitive filters, the plurality of inductive capacitive filters having a straight-line portion and a meandering portion that act as an inductive portion of the inductive capacitive filter and a gap in the meandering portion. The gap in the meandering portion acts as a capacitive portion of the inductive capacitive filter.

In one variant, the base portion is manufactured from a printed circuit board (PCB) material.

In another variant, the base portion to radiator feed structure is manufactured from a plurality of printed circuit boards (PCBs).

In yet another variant, the base portion to radiator feed structure is manufactured from a diecast metal stem with embedded transmission lines.

In yet another variant, the radiator includes a curved radiator.

In yet another variant, the curved radiator is curved cylindrically around a central axis.

In yet another variant, the curved radiator is curved spherically.

In yet another variant, the radiator includes a plurality of segments, with each segment inclined separately from a central axis.

In yet another variant, a shape or layout of at least one of the plurality of inductive capacitive filters on each resonator arm differs from the shape or layout of another inductive capacitive filter on other ones of the resonator arms.

In yet another variant, a shape or layout of at least one of the plurality of inductive capacitive filters differs from another inductive capacitive filter on the same resonator arm.

In yet another variant, at least one inductive capacitive filter is removable and replaceable with an unfiltered conductor.

In yet another variant, the radiator includes a curved radiator which may or may not include inductive capacitive filters.

In another aspect, a multiband antenna assembly that utilizes the aforementioned antenna assembly is disclosed.

In yet another aspect, methods of manufacturing the aforementioned antenna assembly are disclosed.

In yet another aspect, methods of using the aforementioned antenna assembly are disclosed.

Other features and advantages of the present disclosure will immediately be recognized by persons of ordinary skill in the art with reference to the attached drawings and detailed description of exemplary implementations as given below.

### BRIEF DESCRIPTION OF DRAWINGS

The features, objectives, and advantages of the present disclosure will become more apparent from the detailed description set forth below when taken in conjunction with the drawings, wherein:

FIG. 1A is an exemplary first prior art inductive capacitive filter topology, in accordance with the principles of the present disclosure.

FIG. 1B is an exemplary second prior art inductive capacitive filter topology, in accordance with the principles of the present disclosure.

FIG. 1C is an equivalent circuit representation of the filter topologies illustrated in FIGS. 1A and 1B, in accordance with the principles of the present disclosure.

FIG. 2A is a top perspective view of an exemplary antenna assembly, in accordance with the principles of the present disclosure.

FIG. 2B is a bottom perspective view of the antenna assembly of FIG. 2A, in accordance with the principles of the present disclosure.

FIG. 2C is a top plan view of an exemplary radiator for use with the antenna assembly of FIG. 2A, in accordance with the principles of the present disclosure.

FIG. 2D is a detailed view of an exemplary resonator arm of the radiator of FIG. 2C, in accordance with the principles of the present disclosure.

FIG. 3A is a top perspective view of an exemplary curved antenna assembly, in accordance with the principles of the present disclosure.

FIG. 3B is a bottom perspective view of the curved antenna assembly of FIG. 3A, in accordance with the principles of the present disclosure.

FIG. 3C is a top plan view of an exemplary curved radiator for use with the curved antenna assembly of FIG. 3A, in accordance with the principles of the present disclosure.

FIG. 3D is a detailed view of an exemplary resonator arm of the curved radiator of FIG. 3C, in accordance with the principles of the present disclosure.

FIG. 4 is a structure for an alternative curved radiator, in accordance with the principles of the present disclosure.

### DETAILED DESCRIPTION

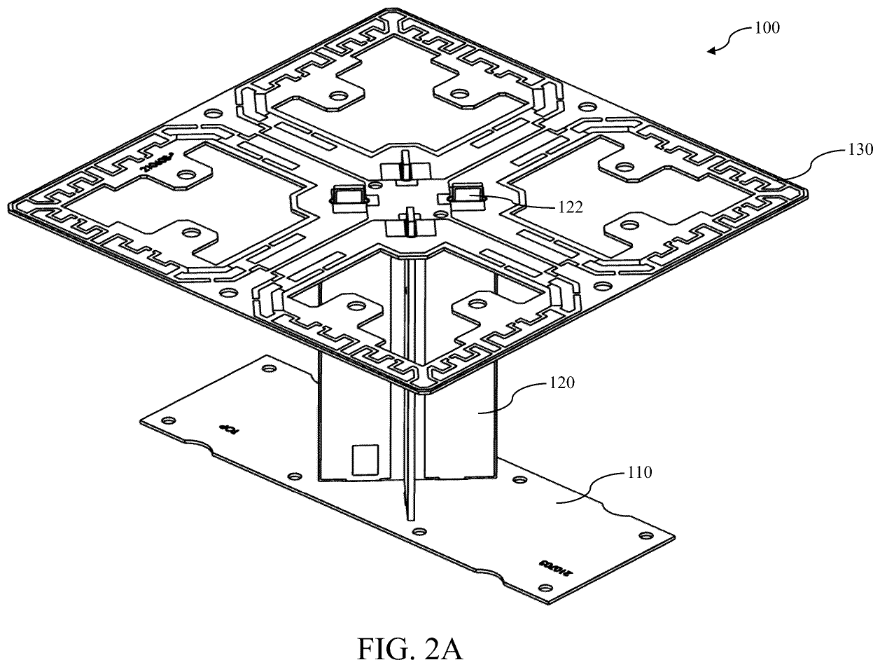

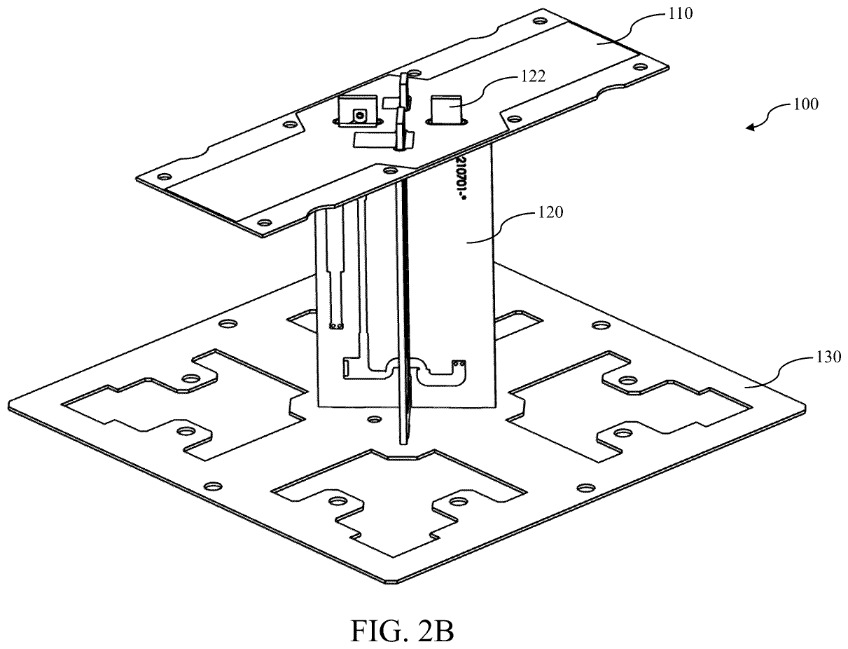

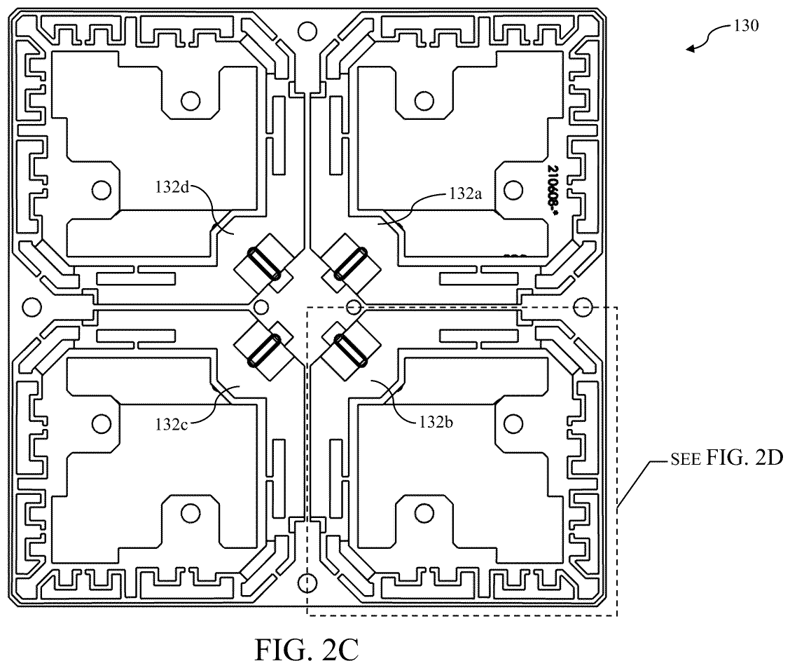

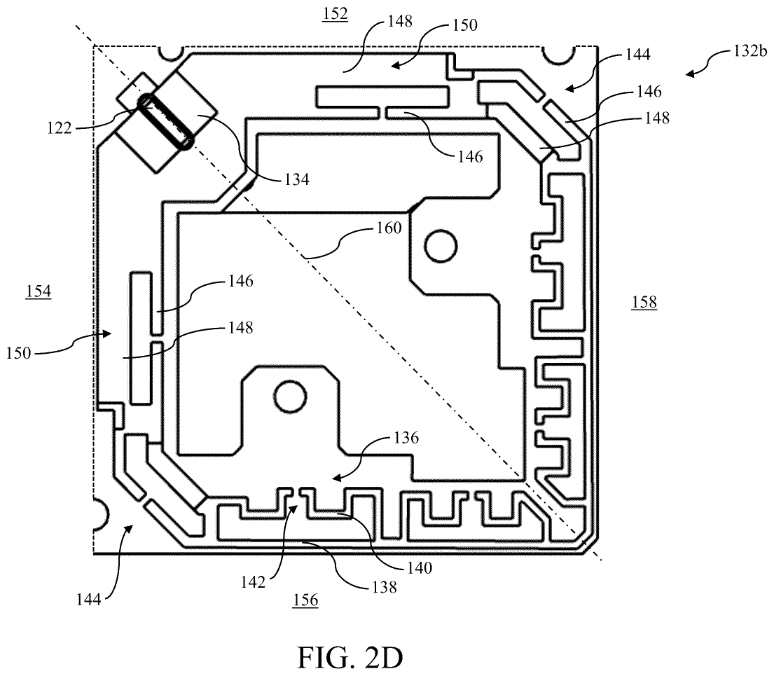

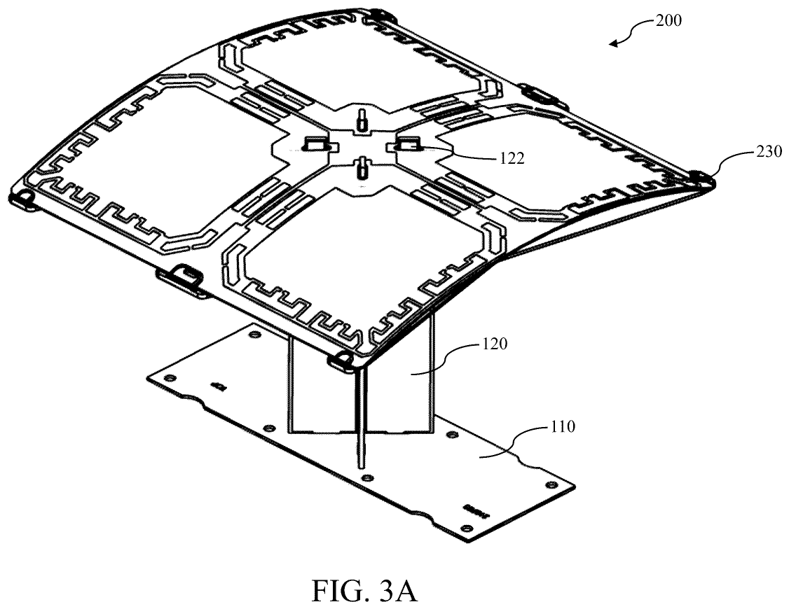

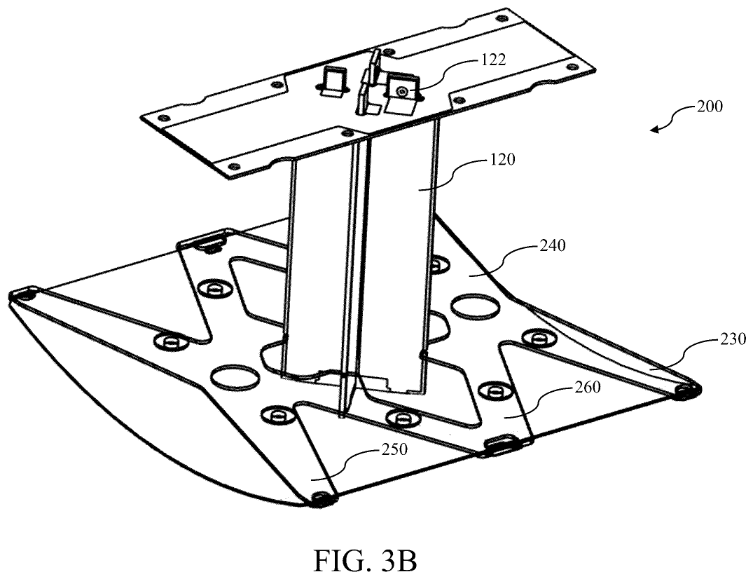

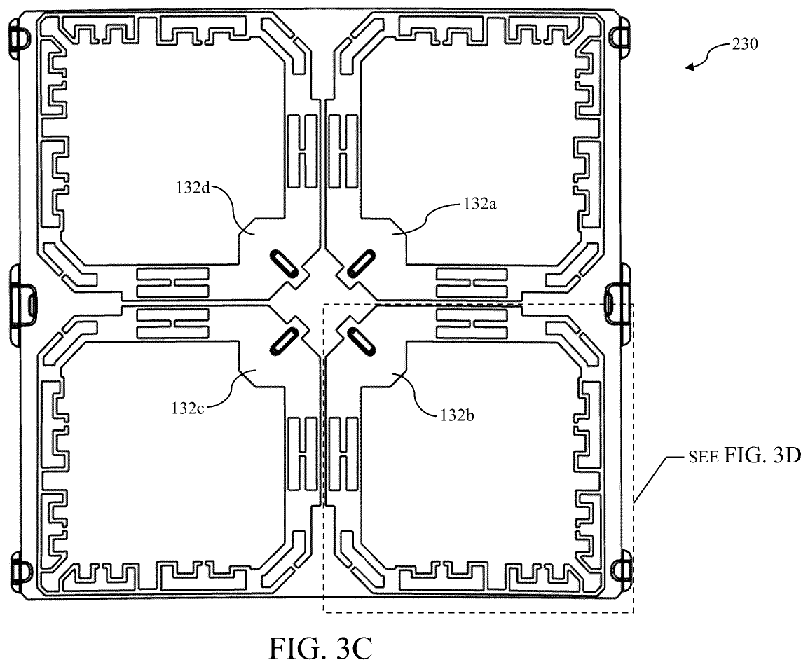

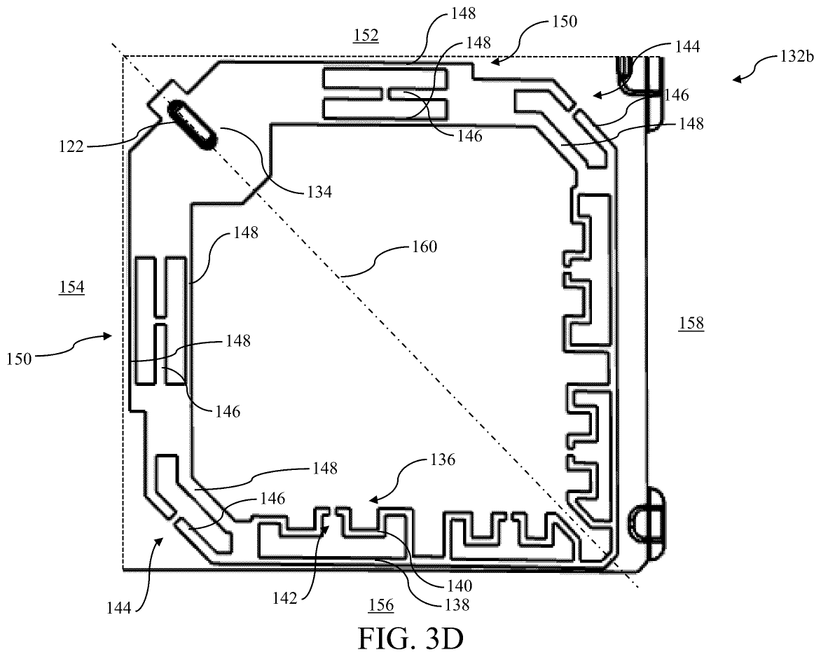

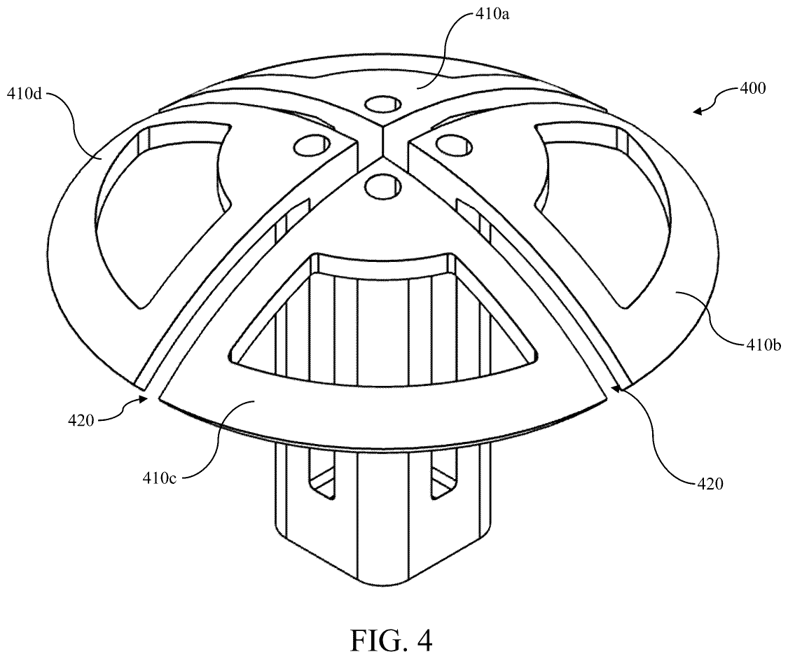

Detailed descriptions of the various embodiments and variants of the apparatus and methods of the present disclosure are now provided. It is noted that wherever practicable similar or like reference numbers may be used in the figures and may indicate similar or like functionality. The figures depict embodiments of the disclosed system (or methods) for purposes of illustration only. One skilled in the art will readily recognize from the following description that alternative embodiments of the structures and methods illustrated herein may be employed without necessarily departing from the principles described herein. For example, the resonator art layout illustrated in FIG. 2D may be incorporated into the curved resonator art layout illustrated in FIG. 3D and vice versa. Additionally, the resonator art layout illustrated in FIGS. 2D and 3D may be utilized with the structure illustrated in FIG. 4.

While primarily discussed in the context of antenna designs that “cloak” low band elements (e.g., from 698-960 MHz) from affecting operation of co-located high band elements operating in, for example, a frequency band that runs from 1427 MHz to 2690 MHz, it is not necessarily a prerequisite that antenna designs be confined to these two frequency bands. For example, it is appreciated that aspects of the present disclosure may be readily adapted to other frequency bands of interest with the aforementioned frequency bands (i.e., from 698-960 MHz and 1427-2690 MHz) merely being exemplary. These and other variants would be readily apparent to one of ordinary skill given the contents of the present disclosure.

### Exemplary Multiband Antenna Systems—

Low band radiating elements are typically large in terms of physical size. As a result, the low band elements tend to scatter high band signals while also having multiple modes of resonance at the high band frequencies. Traditional approaches to mitigate these effects on the high band arrays use filtering approaches to impede, for example, high band signal flow on the low band dipole structures. Earlier approaches broke the low band dipole arms into segments that were separated by inductive tracks that present a high impedance to the high band signals while allowing the low band signals to propagate. As a result, the relatively small segments are too small to resonate at the higher frequencies so that the high band current flow on the low band dipole arms is suppressed. Unfortunately, the inductive segments increase the electrical length of the low band dipole, and the number of segments required to effectively filter the high band frequencies results in a dipole that is too large electrically for the low band, thereby preventing satisfactory wideband impedance matching of the low band dipole.

Existing filtering resonator approaches on the low band dipole arms are relatively good at filtering the higher band signals over the commonly used higher band frequency range of 1710-2690 MHz, as is commonly used in the mobile wireless cellular networks widely deployed today. However, new frequency bands are continually being added for use in cellular networks and one commonly used relatively new frequency band is the 1427-1525 MHz band, known generically in the industry as the “L-band”. As a result, mobile wireless network operators (MNO's) are seeking designs that widen the band of operation for the higher band to 1427-2690 MHz. Consequently, the resonator filters on the low band dipole arms are required to have significantly wider bandwidth and lower center frequencies. These lower center frequency designs require longer length resonators so that the filters needed are required to get physically longer. Unfortunately, these filters cannot be arbitrarily lengthened without changing the resonant length of the dipole arms in the low band leading to mismatched low band dipoles.

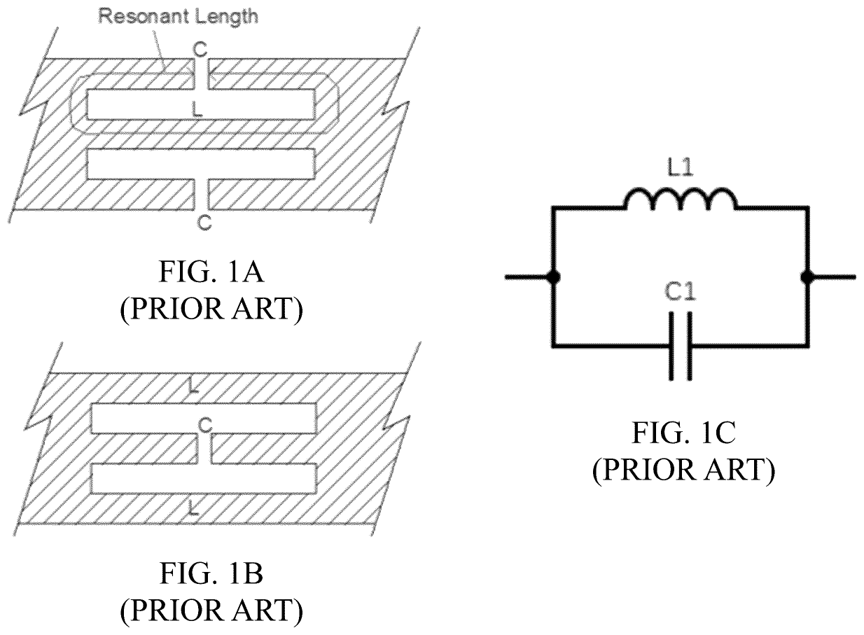

Referring now to FIGS. 1A-1C, standard existing filter resonator designs are shown with the filter topologies seen in FIGS. 1A-1B shown as being cut from a low band dipole arm, along with an approximate equivalent circuit illustrated in FIG. 1C. FIG. 1A illustrates a filter topology in which there is a single connecting track and two open loops, while FIG. 1B illustrates a filter topology in which there are two connecting tracks and an open track in the middle portion of the filter. Although not illustrated, filter topologies that include a single open track and a single connecting track have also been implemented. The connecting tracks in FIGS. 1A and 1B may be thought of as the inductive (“L”) part of the circuit with the open gaps acting as the capacitive (“C”) part of the circuit. In combination, the L and C portions of these circuits that are placed in parallel can form an open circuit at the resonant frequency, thereby blocking current flow. At lower frequencies than resonance, most current flows in the L track, and above resonance the L track has a high impedance and thus most signal flows through the C gap. This effectively creates a band-stop filter, and the bandwidth is increased by increasing the L track length and/or increasing the size of the C track gap. The combination of L and C sets the center frequency of the filter. A problem with this filter design topology arises when the filter needs to block lower and lower frequencies, for example down to 1427 MHz, and therefore the inductance gets too high as the filter lengthens which increases the dipole arm length and detunes the dipole. The impedance of the arms also gets high for the low band which impacts the overall bandwidth as well. The top of the low band frequency range becomes seriously affected and accordingly, with this topology of filter, it is difficult to simultaneously improve the filtering at the lower high band frequencies while maintaining the low band impedance match.

Referring now to FIGS. 2A-2D, an exemplary low band dual-polarized antenna assembly 100 is illustrated which addresses the deficiencies associated with the filter topologies illustrated in FIGS. 1A and 1B. FIGS. 2A-2B illustrate the main components of the low band antenna assembly 100 which consists of: (1) the base portion 110 (which may function as the interface between the antenna assembly 100 and a reflector (not shown)); (2) the base portion to radiator structure 120; and (3) the radiator 130. In some implementations, the base portion 110 and the base portion to radiator feed structure 120 may be manufactured from common printed circuit board (PCB) materials such as, for example, FR-4. However, in some implementations, the base portion 110 and/or the base portion to radiator feed structure 120 may be manufactured from a diecast stem (or diecast metal), as either separate and distinct components, or as a common component that is manufactured together. In some implementations, the base portion 110 and the base portion to radiator feed structure 120 may be manufactured from sheet metal or as cables (e.g., coaxial cables). The base portion 110 may be omitted in some implementations, with the dipole stems being bolted directly to a reflector (not shown). As illustrated, the base portion 110 is generally parallel with the radiator 130, while the base portion to radiator feed structure 120 is arranged generally orthogonal to the base portion 110 and the radiator 130. The base portion to radiator feed structure 120 also includes interface connections 122, which when soldered, physically and electrically connect the base portion to radiator feed structure 120 to both the base portion 110 and the radiator 130. In some implementations, the interface connections 122 may be capacitively coupled to the radiator 130, instead of (or in addition to), the soldered connections as described above.

Referring now to FIG. 2C, a top plan view of a dual-polarized dipole radiator 130 is shown that includes four (4) low band resonator arms 132, namely: (1) the upper right low band resonator arm 132a; (2) the lower right low band resonator arm 132b; (3) the lower left low band resonator arm 132c; and (4) the upper left low band resonator arm 132d. As a brief aside, while described in the context of a given frame of reference such as upper right, lower right, lower left, and upper left, it will be appreciated by one of ordinary skill that each of these positional descriptions is arbitrary and when viewed from a different perspective, each of these positional descriptions such as, for example, upper right may be each of lower right, lower left, and upper left, dependent upon the orientation of the view of the radiator 130. In some implementations, two of these resonator arms 132 form a dipole. For example, the upper right low band resonator arm 132a and the lower left low band resonator arm 132c may form a first dipole, while the upper left low band resonator arm 132d and the lower right low band resonator arm 132 may form a second dipole. For single polarization implementations, two vertical resonator arms (e.g., 132c and 132d or 132a and 132b) may form a dipole, or two horizontal vertical resonator arms (e.g., 132a and 132d or 132b and 132c) may form a dipole. These and other variations would be readily apparent to one of ordinary skill given the contents of the present disclosure. In some implementations, the radiator 130 may be manufactured from a semi-rigid PCB (e.g., FR-4 material), although other implementations may utilize flex circuits in which electronic circuits are disposed on, for example, flexible plastic substrates such as polyimide, transparent conductive polyester film, polyether ether ketone (PEEK), or other known flex circuit materials. In yet other implementations, the radiator 130 may be manufactured using a laser direct sintering (LDS) process, or may be manufactured from conductive metal (e.g., conductive sheet metal, conductive die-cast metals, etc.).

Each of these low band resonator arms 132 may be substantially identical in terms of electrical layout to other ones of the low band resonator arms 132. For example, the upper left low band resonator arm 132d may be substantially identical with (albeit oriented differently) then each of the upper right low band resonator arm 132a, the lower right low band resonator arm 132b and the lower left low band resonator arm 132c. Alternatively, each of these low band resonator arms 132 (or portions of these low band resonator arms 132) may be different from other ones of the low band resonator arms 132. For example, a meandering portion 140 of an inductive capacitive filter 136, 144, 150 within a given low band resonator arm 132 may have a different length than another meandering portion of another given low band resonator arm 132. Moreover, the size of a given gap 142 within a given inductive capacitive filter 136, 144, 150 may differ from the gap 142 within another inductive capacitive filter 136, 144, 150, whether within the same low band resonator arm 132, or whether within a different low band resonator arm 132. These and other variations would be readily apparent to one of ordinary skill given the contents of the present disclosure. Moreover, in some implementations, one or all of the inductive capacitive filters 136, 144, 150 may be removed from some or all of the low band resonator arms 132 in, for example, curved radiator embodiments (such as, for example, curved radiator 230 shown in FIGS. 3A-3D), or in single band embodiments. These and other variations would be readily apparent to one of ordinary skill given the contents of the present disclosure.

Referring now to FIG. 2D, a detailed plan view of one of the resonator arms 132 (specifically, the lower right low band resonator arm 132b) is shown and described in detail. At the upper left-hand side of the lower right low band resonator 132b is the interface connection 122 that may be coupled with the interface to radiator connection 134 via, for example, a eutectic solder connection. This soldered connection may form a right-angle solder fillet to provide a robust electrical/mechanical connection between the base portion to radiator feed structure 120 and the radiator 130. In some implementations, this solder connection may be made through use of, for example, solder post connections with an external metallic terminal, through use of conductive vias and/or through hole connections in addition to, or alternatively from, the aforementioned solder connection between the interface to radiator connection 134 and the interface connection 122.

On the left side 154 of the lower right low band resonator arm 132b is a middle inductive capacitive filter 150 that includes a closed branch 148 as well as an open branch 146. As discussed elsewhere herein, the closed branch 148 acts as an inductive portion of a filter topology, while the gap in the open branch 146 acts as a capacitive portion of a filter topology. At the lower left corner of the lower right low band resonator arm 132b is a corner inductive capacitive filter 144 consisting of both a closed branch as well as an open branch; however, the closed branch and the open branch of the corner inductive capacitive filter 144 are shown in a reversed order from the open branch 146 and closed branch 148 of the middle inductive capacitive filter 150. On the bottom side 156 of the lower right low band resonator arm 132b are two (2) inductive capacitive filters 136. As a brief aside, while two (2) inductive capacitive filters 136 are illustrated on the bottom side 156 of the lower right low band resonator arm 132b illustrated in FIG. 2D, it would be appreciated in alternative variants that a single inductive capacitive filter 136 or even three (3) or more inductive capacitive filters 136 may be incorporated in some implementations. Each inductive capacitive filter 136 may include a straight-line portion 138 as well as a meandering portion 140 which act as the inductive portion of the inductive capacitive filter 136 as well as an open gap 142 which acts as the capacitive portion of the inductive capacitive filter 136. The meandering portion 140 of the inductive capacitive filter 136 is electrically longer than the straight-line portion 138. As illustrated, the straight-line portion 138 is positioned closer to the bottom side 156 edge of the radiator 130 as compared with the meandering portion 140 of the inductive capacitive filter 136. As illustrated, the open branch 146 of the middle inductive capacitive filter 150 is farther from the left side 154 of the lower right low band resonator arm 132b as compared with the closed branch 148 of the middle inductive capacitive filter 150.

The right side 158 of the lower right low band resonator arm 132b may be substantially identical to the bottom side 156 of the lower right low band resonator arm 132b in that the right side 158 may also include (2) inductive capacitive filters 136 that each consist of a straight-line portion 138 and a meandering portion 140 with an open gap 142. While two (2) inductive capacitive filters 136 are illustrated on the right side 158 of the lower right low band resonator arm 132b illustrated in FIG. 2D, it would be appreciated in alternative variants that a single inductive capacitive filter 136 or even three (3) or more inductive capacitive filters 136 may be incorporated in some implementations. As illustrated in FIG. 2D, the number of inductive capacitive filters 136 is the same between the bottom side 156 and the right side 158 of the lower right low band resonator arm 132b, although it would be appreciated that in some implementations, it may be desirable to have the number of inductive capacitive filters 136 not be equal between the bottom side 156 and the right side 158. The upper right corner of the lower right low band resonator arm 132b includes a corner inductive capacitive filter 144 that is mirrored along line 160. The corner inductive capacitive filter 144 also includes an open branch 146 as well as a closed branch 148 similar to the corner inductive capacitive filter 144 on the lower left corner of the lower right low band resonator arm 132b. Additionally, the top side 152 of the lower right low band resonator arm 132b includes a middle inductive capacitive filter 150 similar to the middle inductive capacitive filter 150 on the left side 154 of the lower right low band resonator arm 132b mirrored about line 160. The middle inductive capacitive filter 150 also includes an open branch 146 as well as a closed branch 148.

Referring now to FIGS. 3A-3D, an exemplary curved low band antenna assembly 200 is illustrated which also addresses the deficiencies associated with the filter topologies illustrated in FIGS. 1A and 1B. FIGS. 3A-3B illustrate the main components of the low band antenna assembly 100 which consists of: (1) the base portion 110 (which may function as the interface between the antenna assembly 100 and a reflector (not shown)); (2) the base portion to radiator feed structure 120; and (3) a curved radiator 230. As illustrated, the base portion to radiator feed structure 120 is arranged generally orthogonal to the base portion 110 and the curved radiator 230. As a brief aside, the use of a curved radiator 230 may allow the radiator 230 to fit within a smaller diameter antenna profile when used in, for example, a cylindrical shaped pole-mounted canister antenna and trisector configurations. These curved radiators 230 may have certain RF performance drawbacks, that may be less than the RF performance characteristics of a flat radiator (as seen in for example, FIGS. 2A-2D); however, in some implementation's customer constraints may require the curved radiator 230 to fit within a certain diameter limit, in which case a curved radiator 230 may be required. The base portion to radiator feed structure 120 also includes interface connections 122, which when soldered, physically and electrically connects the base portion to radiator feed structure 120 to both the base portion 110 and the curved radiator 230.

Referring now to FIG. 3B, the curved radiator support structure 240 is best illustrated. The curved radiator support structure 240 as illustrated includes four (4) corner connection structures 250 that are each adapted to wrap around the four (4) corners of the curved radiator 230. The curved radiator support structure 240 also includes two (2) middle connection structures 260 which are each adapted to wrap around the middle portion of the curved radiator 230. While the curved radiator support structure 240 as illustrated in FIG. 3B includes two (2) middle connection structures 260, it would be readily appreciated by one of ordinary skill given the contents of the present disclosure that alternative variants may obviate the need for the middle connection structures 260 illustrated or may include more than two (2) middle connection structures 260 (e.g., four (4)) in some implementations. Moreover, in some implementations the corner connection structures 250 may be obviated in favor of the middle connection structures 260 in some implementations.

Referring now to FIG. 3C, a top plan view of the curved radiator 230 is shown that includes (4) low band resonator arms 132, namely: (1) the upper right low band resonator arm 132a; (2) the lower right low band resonator arm 132b; (3) the lower left low band resonator arm 132c; and (4) the upper left low band resonator arm 132d. As a brief aside, while described in the context of a given frame of reference such as upper right, lower right, lower left, and upper left, it will be appreciated by one of ordinary skill that each of these positional descriptions is arbitrary and when viewed from a different perspective, each of these positional descriptions such as, for example, upper right may be each of lower right, lower left, and upper left, dependent upon the orientation of the view of the curved radiator 230. In some implementations, two of these resonator arms 132 form a dipole. For example, the upper right low band resonator arm 132a and the lower left low band resonator arm 132c may form a first dipole, while the upper left low band resonator arm 132d and the lower right low band resonator arm 132 may form a second dipole. For single polarization implementations, two vertical resonator arms (e.g., 132c and 132d or 132a and 132b) may form a dipole, or two horizontal vertical resonator arms (e.g., 132a and 132d or 132b and 132c) may form a dipole. These and other variations would be readily apparent to one of ordinary skill given the contents of the present disclosure. In some implementations, the curved radiator 230 may be manufactured from a semi-rigid PCB (e.g., FR-4 material), although other implementations may utilize flex circuits in which electronic circuits are disposed on, for example, flexible plastic substrates such as polyimide, transparent conductive polyester film, polyether ether ketone (PEEK), or other known flex circuit materials. In yet other implementations, the curved radiator 230 may be manufactured using a laser direct sintering (LDS) process, or may be manufactured from conductive metal (e.g., conductive sheet metal, conductive die-cast metals, etc.).

Each of these low band resonator arms 132 may be substantially identical in terms of electrical layout to other ones of the low band resonator arms 132. For example, the upper left low band resonator arm 132d may be substantially identical with (albeit oriented differently) each of the upper right low band resonator arm 132a, the lower right low band resonator arm 132b and the lower left low band resonator arm 132c. Alternatively, each of these low band resonator arms 132 (or portions of these low band resonator arms 132) may be different from other ones of the low band resonator arms 132. For example, a meandering portion 140 of an inductive capacitive filter 136, 144, 150 within a given low band resonator arm 132 may have a different length than another meandering portion of another given low band resonator arm 132. Moreover, the size of a given gap 142 within a given inductive capacitive filter 136, 144, 150 may differ from the gap 142 within another inductive capacitive filter 136, 144, 150, whether within the same low band resonator arm 132, or whether within a different low band resonator arm 132. These and other variations would be readily apparent to one of ordinary skill given the contents of the present disclosure. Moreover, in some implementations, one or all of the inductive capacitive filters 136, 144, 150 may be removed from some or all of the low band resonator arms 132 in, for example, curved radiator embodiments (such as curved radiator 230 shown in FIGS. 3A-3D), or in single band embodiments. These and other variations would be readily apparent to one of ordinary skill given the contents of the present disclosure.

Referring now to FIG. 3D, a detailed plan view of one of the resonator arms 132 (specifically, the lower right low band resonator arm 132b) is shown and described in detail. At the upper left-hand side of the lower right low band resonator 132b is the interface connection 122 that may be coupled with the interface to radiator connection 134 via, for example, a eutectic solder connection. This soldered connection may form a right-angle solder fillet to provide a robust electrical/mechanical connection between the base portion to radiator feed structure 120 and the curved radiator 230. In some implementations, this solder connection may be made through use of, for example, solder post connections with an external metallic terminal, through use of conductive vias and/or through hole connections in addition to, or alternatively from, the aforementioned solder connection between the interface to radiator connection 134 and the interface connection 122.

On the left side 154 of the lower right low band resonator arm 132b is a middle inductive capacitive filter 150 that includes an open branch 146 as well as two closed branches 148 disposed on either side of the open branch 146. As discussed elsewhere herein, the closed branches 148 act as inductive portions of a filter topology, while the open branch 146 acts as a capacitive portion of a filter topology similar to the topology illustrated in FIG. 1B. In some implementations, the middle inductive capacitive filter 150 may be similar to the middle inductive capacitive filter 150 illustrated in FIG. 2D and vice versa (i.e., the middle inductive capacitive filter 150 of FIG. 3D may be used in the lower right low band resonator arm 132b of FIG. 2D instead of the middle inductive capacitive filter 150 illustrated in FIG. 2D). At the lower left corner of the lower right low band resonator arm 132b is a corner inductive capacitive filter 144 consisting of both a closed branch 148 as well as an open branch 146. On the bottom side 156 of the lower right low band resonator arm 132b are two (2) inductive capacitive filters 136. As a brief aside, while two (2) inductive capacitive filters 136 are illustrated on the bottom side 156 of the lower right low band resonator arm 132b illustrated in FIG. 3D, it would be appreciated in alternative variants that a single inductive capacitive filter 136 or even three (3) or more inductive capacitive filters 136 may be incorporated in some implementations. Each inductive capacitive filter 136 may include a straight-line portion 138 and meandering portion 140 which act as the inductive portion of the inductive capacitive filter 136 as well as an open gap 142 which acts as the capacitive portion of the inductive capacitive filter 136. The meandering portion 140 of the inductive capacitive filter 136 is electrically longer than the straight-line portion 138. As illustrated, the straight-line portion 138 is positioned closer to the bottom side 156 edge of the curved radiator 230 as compared with the meandering portion 140 of the inductive capacitive filter 136.

The right side 158 of the lower right low band resonator arm 132b may be substantially identical to the bottom side 156 of the lower right low band resonator arm 132b in that the right side 158 may also include (2) inductive capacitive filters 136 that each consist of a straight-line portion 138 and a meandering portion 140 with an open gap 142. While two (2) inductive capacitive filters 136 are illustrated on the right side 158 of the lower right low band resonator arm 132b illustrated in FIG. 3D, it would be appreciated in alternative variants that a single inductive capacitive filter 136 or even three (3) or more inductive capacitive filters 136 may be incorporated in some implementations. As illustrated in FIG. 3D, the number of inductive capacitive filters 136 is the same between the bottom side 156 and the right side 158 of the lower right low band resonator arm 132b, although it would be appreciated that in some implementations, it may be desirable to have the number of inductive capacitive filters 136 not be equal between the bottom side 156 and the right side 158. The upper right corner of the lower right low band resonator arm 132b includes a corner inductive capacitive filter 144 that is mirrored along line 160. The corner inductive capacitive filter 144 also includes an open branch 146 as well as a closed branch 148 similar to the corner inductive capacitive filter 144 on the lower left corner of the lower right low band resonator arm 132b. Additionally, the top side 152 of the lower right low band resonator arm 132b includes a middle inductive capacitive filter 150 similar to the middle inductive capacitive filter 150 on the left side 154 of the lower right low band resonator arm 132b mirrored about line 160. The middle inductive capacitive filter 150 also includes an open branch 146 as well as two closed branches 148.

Referring now to FIG. 4, an alternative structure 400 is illustrated which may support a curved radiator 230 and allow the curved radiator 230 to be shaped into a spherical curved configuration. In other words, unlike the embodiment illustrated in FIGS. 3A-3D in which the curved radiator 230 is curved around a single axis, the structure 400 enables the curved radiator 230 to be curved into a portion of a sphere. In such an implementation, the curved radiator 230 may be manufactured from a semi-rigid PCB (e.g., FR-4 material), although other implementations may utilize flex circuits in which electronic circuits are disposed on, for example, flexible plastic substrates such as polyimide, transparent conductive polyester film, polyether ether ketone (PEEK), or other known flex circuit materials. In some implementations, gaps (not shown) may be incorporated into the curved radiator 230 substrate to enable a planar substrate to conform to the curvature of the quadrants 410a, 410b, 410c, 410d. Gaps 420 within the structure 400 itself enable a curved radiator support structure (similar to curved radiator support structure 240) to capture, for example, the corners of the curved radiator 230 thereby enabling the curved radiator 230 to form a portion of a spherical shape, while the quadrants 410a, 410b, 410c, 410d between these gaps 420 support the curved radiator 230. Such a structure 400 may be advantageous in that each of the low band resonator arms 132 are each identically curved with respect to one another optimizing the electrical performance of these low band resonator arms 132 by minimizing interference between each of these low band resonator arms 132. Additionally, due to the spherical curvature of the curved radiator 230, the curved radiator 230 may be accommodated into a smaller diameter cylindrical housing as compared with the curved radiator 230 illustrated in FIGS. 3A-3D.

In some implementations, the curved radiator 230 may be bodily incorporated into the quadrants 410a, 410b, 410c, 410d themselves. For example, the curved radiator 230 can be manufactured from a conductive die-cast metal or conductive sheet metal. As but another example, the curved radiator 230 may be manufactured using, for example, a laser direct sintering (LDS) process. Such implementations may be advantageous in that such curved radiators 230 may not necessarily require a curved radiator support structure (similar to curved radiator support structure 240) in order to form the spherical shape. While a specific structure 400 is illustrated with respect to FIG. 4, it would be readily apparent to one of ordinary skill that alternative structures 400 could be envisioned which would enable a curved radiator 230 to be shaped into a spherical shape, given the contents of the present disclosure.

It will be recognized that while certain aspects of the present disclosure are described in terms of specific design examples, these descriptions are only illustrative of the broader methods of the disclosure and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

1. An antenna assembly comprising:
a base portion functioning as an interface between the antenna assembly and a reflector;
a base portion to radiator feed structure; and
a radiator, the radiator comprising:
a plurality of resonator arms, each of the resonator arms comprising a plurality of inductive capacitive filters, the plurality of inductive capacitive filters comprising a straight-line portion and a meandering portion that act as an inductive portion of the inductive capacitive filter and a gap in the meandering portion, wherein the gap in the meandering portion acts as a capacitive portion of the inductive capacitive filter.

2. The antenna assembly of claim 1, wherein the base portion is manufactured from a printed circuit board (PCB) material.

3. The antenna assembly of claim 2, wherein at least one inductive capacitive filter is removable and replaceable with an unfiltered conductor.

4. The antenna assembly of claim 1, wherein the base portion to radiator feed structure is manufactured from a plurality of printed circuit boards (PCBs).

5. The antenna assembly of claim 4, wherein at least one inductive capacitive filter is removable and replaceable with an unfiltered conductor.

6. The antenna assembly of claim 1, wherein the base portion to radiator feed structure is manufactured from a diecast metal stem with embedded transmission lines.

7. The antenna assembly of claim 6, wherein at least one inductive capacitive filter is removable and replaceable with an unfiltered conductor.

8. The antenna assembly of claim 1, wherein the radiator comprises a curved radiator.

9. The antenna assembly of claim 8, wherein at least one inductive capacitive filter is removable and replaceable with an unfiltered conductor.

10. The antenna assembly of claim 8, wherein the curved radiator is curved cylindrically around a central axis.

11. The antenna assembly of claim 8, wherein the curved radiator is curved spherically.

12. The antenna assembly of claim 1, wherein the radiator comprises a plurality of segments, with each segment inclined separately from a central axis.

13. The antenna assembly of claim 12, wherein at least one inductive capacitive filter is removable and replaceable with an unfiltered conductor.

14. The antenna assembly of claim 12, wherein a shape or layout of at least one of the plurality of inductive capacitive filters on each resonator arm differs from the shape or layout of another inductive capacitive filter on other ones of the resonator arms.

15. The antenna assembly of claim 14, wherein at least one inductive capacitive filter is removable and replaceable with an unfiltered conductor.

16. The antenna assembly of claim 14, wherein a shape or layout of the plurality of inductive capacitive filters differs between each of the plurality of resonator arms.

17. The antenna assembly of claim 16, wherein at least one inductive capacitive filter is removable and replaceable with an unfiltered conductor.

18. The antenna assembly of claim 1, wherein a shape or layout of the plurality of inductive capacitive filters differs between each of the plurality of resonator arms.

19. The antenna assembly of claim 1, wherein a shape or layout of at least one of the plurality of inductive capacitive filters on each resonator arm differs from the shape or layout of another inductive capacitive filter on the same resonator arm.

20. The antenna assembly of claim 19, wherein a shape or layout of the plurality of inductive capacitive filters differs between each of the plurality of resonator arms.
